(19) United States
(12) Patent Application Publication
(10) Pub. No.: US 2015/0053435 A1
(43) Pub. Date: Feb. 26, 2015

(54) DRIVE SYSTEM FOR VEHICLE PULLING A TOWED VEHICLE

(71) Applicant: Deere & Company, Moline, IL (US)

(72) Inventors: Bernard E. Romig, Illinois City, IL (US); Bryan K. Buerkle, Cedar Falls, IA (US); Lynelle K. Stahlhut, Bettendorf, IA (US)

(73) Assignee: Deere & Company, Moline, IL (US)

(21) Appl. No.: 13/970,698

(22) Filed: Aug. 20, 2013

(51) Int. Cl. E02F 3/84; B62D 53/00; B62D 59/04; E02F 3/76

(52) U.S. Cl. CPC E02F 3/84; E02F 3/7663; B62D 53/00; B62D 59/04
USPC 172/3; 701/22

(57) ABSTRACT

A drive system is provided for a towing vehicle pulling a towed vehicle, such as a tractor pulling a scraper. The drive system includes a diesel engine which drives a generator for generating electrical power. Tractor drive motors are drivingly connected to driven wheels of the tractor. An assist drive motor is drivingly connected to driven wheels of the scraper. A power distribution unit controls distribution of electric power from the generator to the tractor and assist drive motors. A control unit controls the power distribution unit as a function of vehicle speed.

### FIELD OF THE INVENTION

The present disclosure relates to a drive system for a vehicle pulling a towed vehicle.

### BACKGROUND OF THE INVENTION

A tractor pulling a scraper is an example of a towing vehicle pulling a towed vehicle. Such earth moving towed scrapers are heavy and often operate in soft soils. This results in a rolling resistance which represents a large fraction of the tractor drawbar pull needed to load the scraper and climb steep grades. The weight carried by the scraper tires, combined with the soil conditions on which the machine is normally used, results in a potential for delivering tractive power to move the machine. If this tractive potential can be utilized, the drawbar pull needed from the tractor while loading the scraper and climbing steep grades can be reduced. A reduction in the maximum drawbar pull required allows ballast to be removed from the tractor and lowers the parasitic losses due to the rolling resistance of the entire tractor-scraper system. The operational advantage gained is twofold. Reduced parasitic losses allow for higher speeds and more productive operation during those portions of the operating cycle where full engine power can be utilized. There is also a fuel economy advantage during the entire cycle.

### SUMMARY

According to an aspect of the present disclosure, a drive system is provided for a towing vehicle pulling a towed vehicle, such as a tractor pulling a towed scraper. The drive system includes a power generating unit on the tractor, such as a diesel engine which drives a generator for generating electrical power. Tractor drive motors are drivingly connected to driven wheels of the tractor. An assist drive motor is drivingly connected to driven wheels of the scraper. A power distribution unit controls distribution of electric power from the generator to the tractor drive motors and to the assist drive motor. A control unit controls the power distribution unit in response to a vehicle speed signal. The control unit, below a first speed threshold, causes a first greater portion of the power to be applied to the tractor drive motors and causing a second lesser portion of the power to be applied to the assist drive motor. The control unit, above a second speed threshold, causes all of the power to be applied to the tractor drive motors and causes none of the power to be applied to the assist drive motor.

### BRIEF DESCRIPTION OF THE DRAWINGS

FIG. 1 is a simplified schematic diagram of a drive system for a vehicle pulling a towed vehicle and embodying the invention;

FIG. 2 is a schematic block diagram of the drive system of FIG. 1;

FIG. 3 is a flow chart of an algorithm performed by a control unit FIG. 2; and

FIG. 4 is a graphical representation of a function performed by the algorithm of FIG. 3.

### DETAILED DESCRIPTION OF THE DRAWINGS

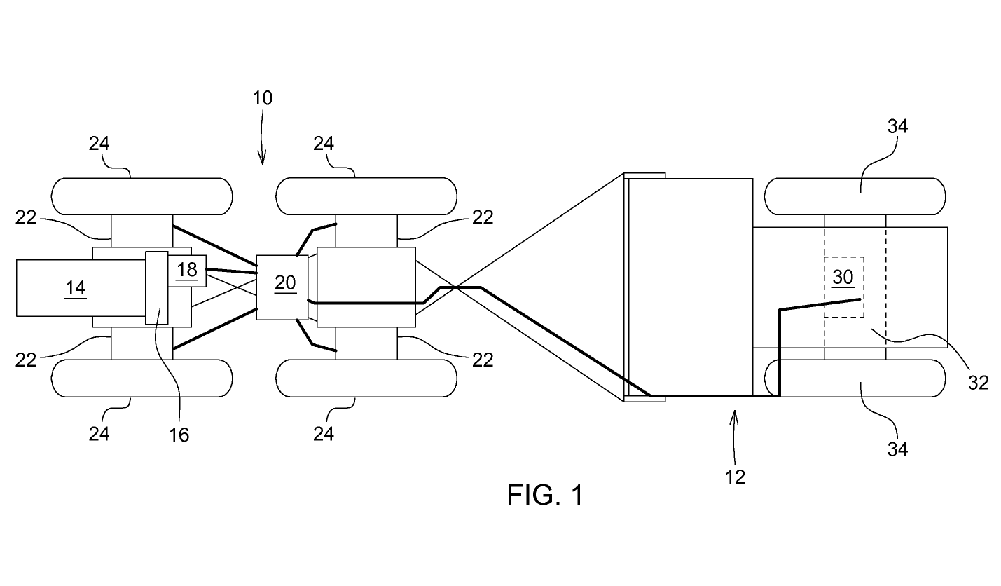

Referring to FIG. 1, a drive system is provided for a towing vehicle or tractor 10 which pulls a towed vehicle 12. The towing vehicle 10 may be an agricultural tractor. The towed vehicle 12 may be a pull-type scraper. The tractor 10 includes an engine 14, such as a Diesel engine, which drives a gearbox 16 which drives an electric generator 18. The generator 18 provides electrical power to a power electronics unit 20. The power electronics unit 20 distributes electrical power to electric motor and final drive units 22 which drive corresponding vehicle wheels 24. Alternatively, the tractor 10 may have an engine which drives a generator and which drives a mechanical transmission which provides mechanical power to driven wheels of the tractor. Alternatively, instead of a diesel engine driving a generator, the tractor 10 may have a known fuel cell and power electronics for generating electrical power. Thus, this invention requires a tractor 10 with some sort of electric drive train. This would normally be a Diesel electric system somewhat similar to a locomotive. The prime mover could be any sort of combustion engine or fuel cell of adequate capacity, and the electric power would normally be used to power the drive axles of the tractor 10.

The towed vehicle 12 includes an electric assist motor 30 which receives electrical power from the power electronics unit 20. The assist motor 30 drives an axle 32 which drives wheels 34 of the towed vehicle 12.

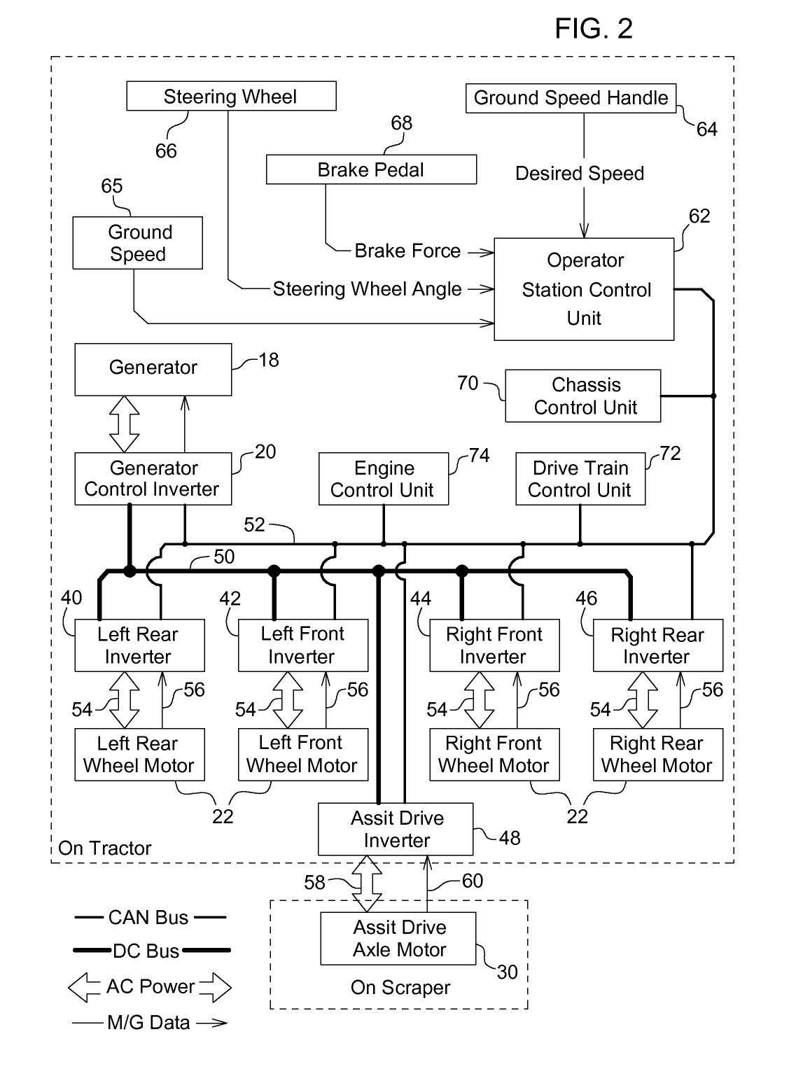

As best seen in FIG. 2, the generator 18 is operatively connected to the power electronics unit 20 which is preferably a generator control/inverter. The generator control/inverter 20 is operatively connected to a left rear inverter 40, a left front inverter 42, a right front inverter 44 and a right rear inverter 46, each of which drives a corresponding wheel drive motor 22. The generator control/inverter 20 is also connected to an assist drive inverter 48 which provides electrical power and control to the dive motor 30 on the towed vehicle 12. Units 20 and 40-48 are connected together by a DC bus 50 and by a CAN bus 52. Units 40-48 are connected to drive motors 22 by four separate identical AC power buses 54 and by four separate identical M/G data buses 56. Unit 48 is connected to drive motor 30 by AC power bus 58 and by an M/G data bus 60.

An operator station control unit 62 receives a desired speed signal from a speed input device 64, such as an operator-controlled speed control handle. The operator station control unit 62 receives a sensed ground speed signal from a speed sensor 65. The sensed ground speed may be a ground speed calculated from axle rpm, or true ground speed as sensed by radar or GPS (not shown). The operator station control unit 62 may also receive information from a steering wheel 66 and a brake pedal 66. Control unit 62, a chassis control unit 70, a drive train control unit 72 and an engine control unit 74 are all connected to the CAN bus 52.

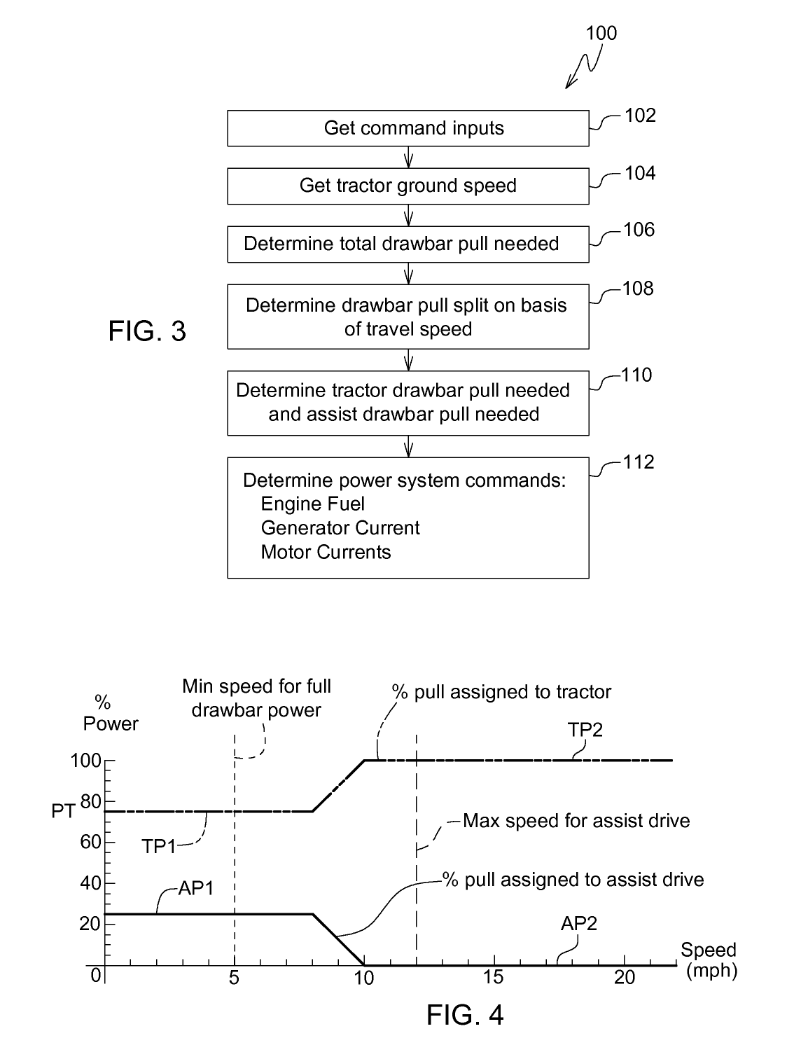

One or more of the control units executes the algorithm 100 illustrated by the flow chart shown in FIG. 3. The conversion of this flow chart into a standard language for implementing the algorithm described by the flow chart in a digital computer or microprocessor, will be evident to one with ordinary skill in the art.

In step 102 the ECU receives various inputs, including a desired speed signal from speed input device 64.

In step 104 the ECU receives a sensed ground speed value from sensor 65.

Then, step 106 determines the total power or pull required to move the tractor 10 and the towed vehicle 12 at the desired speed. Preferably, this determination is done by a speed control loop (not shown) which attempts to maintain a set speed as a function of the sensed ground speed from step 104 and the desired speed from the speed input device 64. In some cases the operator would be given more direct control, perhaps with the position of a foot pedal being interpreted as 0 to 100% pull. The speed control loop, when used may be any of the commonly known types up to and including a PID (Proportional Integral Derivative) algorithm. This is all expressed in terms of pull since the speed ratio between engine and axles is allowed to vary along a constant engine power curve. Answering a request for more pull when the engine is already at maximum power entails slowing down but the speed control loop will recover to the requested speed before allowing the engine to drop below rated power. Also, in some applications, the ratio of pull to axle torque is close enough to constant so that axle torque can be used to determine pull without additional instrumentation.

Step 108 then determines how the total power from step 106 should be split between the tractor wheel drive motors 22 and the towed vehicle drive motor 30. This function is illustrated graphically by FIG. 4 and may be executed by control unit 70. Referring now to FIG. 4, for ground speeds between zero and a first speed threshold (such as 8 miles per hour (mph)) the ECU maintains the percentage or portion of the electrical power or pull which is applied to the tractor drive motors 22 at a first tractor power level TP1, such as slightly less than 80%, and the ECU maintains the percentage or portion of the electrical power or pull which is applied to the assist drive motor 30 at a first assist power level AP1, such as slightly more than 20%. For ground speeds between at or above a second speed threshold (such as 10 mph) the ECU maintains the percentage or portion of the electrical power or pull which is applied to the tractor drive motors 22 at a second higher tractor power level TP2, such as 100%, and the ECU maintains the percentage or portion of the electrical power or pull which is applied to the assist drive motor 30 at a second lower assist power level AP2, such as zero %. For ground speeds between the first and second speed thresholds, the portion of the electrical power or pull which is applied to the tractor drive motors 22 preferably varies in a linear manner, as does the portion of the electrical power or pull which is applied to the assist drive motor 30.

Step 110 then determines the required amount of tractor power or pull and the required amount of assist drive power or pull using the values determined by steps 106 and 108.

Step 112 then generates commands fuel for engine 14, current for generator 18 and currents for motors 22 and 30 in order to cause motors 22 and 30 to applied the amounts of power or pull determined in step 110 to the tractor 10 and to the towed vehicle, respectively.

The result is a drive system wherein an electric motor supplies propulsive power to an axle supporting a towed scraper to reduce the drawbar pull needed from the tractor that is pulling and powering the scraper. The electric power is diverted from the tractor electric drive train components to provide a power assist at low operating speeds. This reduces the need for ballast weights on the tractor, and reduces the empty weight of the machine.

If desired, the power or pull commands could be limited as a function of sensed parameters such as engine output, electric machine currents and the like.

While the disclosure has been illustrated and described in detail in the drawings and foregoing description, such illustration and description is to be considered as exemplary and not restrictive in character, it being understood that illustrative embodiments have been shown and described and that all changes and modifications that come within the spirit of the disclosure are desired to be protected. It will be noted that alternative embodiments of the present disclosure may not include all of the features described yet still benefit from at least some of the advantages of such features. Those of ordinary skill in the art may readily devise their own implementations that incorporate one or more of the features of the present disclosure and fall within the spirit and scope of the present invention as defined by the appended claims.

We claim:

1. A drive system for a towing vehicle pulling a towed vehicle, the drive system comprising:
power generating unit, including a generator for generating electrical power;
a towing vehicle drive motor drivingly connected to a driven wheel of the towing vehicle;
a towed vehicle drive motor drivingly connected to a driven wheel of the towed vehicle;
a power distribution unit for controlling distribution of electric power from the generator to the towing vehicle drive motor and to the towed vehicle drive motor; and
a control unit for controlling the power distribution unit in response to a vehicle speed signal, the control unit, below a first speed threshold, causing a first greater portion of the power to be applied to the towing vehicle drive motor and causing a second lesser portion of the power to be applied to the towed vehicle drive motor, and the control unit, above a second speed threshold, causing all of the power to be applied to the towing vehicle drive motor and causing none of the power to be applied to the towed vehicle drive motor.

2. The drive system of claim 1, wherein:
the control unit, between the first and second threshold speeds, gradually increases power applied to the towing vehicle drive motor.

3. The drive system of claim 1, wherein:
the control unit, between the zero ground speed and the first threshold speeds, applies a constant amount of power to the towing vehicle drive motor.

4. The drive system of claim 1, wherein:
the towing vehicle comprises a tractor; and
the towed vehicle comprises a scraper.

5. A drive system for a tractor pulling a scraper, the drive system comprising:
power generating unit on the tractor, including a generator for generating electrical power;
tractor electric drive motors powered by the generator and drivingly connected to driven wheels of the tractor;
a scraper drive motor drivingly connected to driven wheels of the scraper;
a power distribution unit for controlling distribution of electric power from the generator to the tractor drive motors and to the scraper drive motor; and
a control unit for controlling the power distribution unit as a function of commanded and sensed tractor speed.

6. The drive system of claim 5, wherein:
the control unit, below a first speed threshold, causing a first portion of the power to be applied to the tractor drive motors and causing a second portion of the power to be applied to the scraper drive motor, and the control unit, above a second speed threshold, causing a third portion of the power to be applied to the tractor drive motors and causing a fourth portion of the power to be applied to the scraper drive motor, the third portion being larger than the first portion, and the first portion being greater than the second portion.

7. The drive system of claim 6, wherein:
the control unit, above the second speed threshold, causing all of the power to be applied to the tractor drive motors and causing none of the power to be applied to the scraper drive motor.
